(19) United States
(12) Patent Application Publication
(10) Pub. No.: US 2026/0318116 A1
(43) Pub. Date: Oct. 15, 2026

(54) SMART AUTOMATED DOOR MOVEMENT SYSTEM AND METHOD

(71) Applicant: Samuel Slaboden, Culver City, CA (US)

(72) Inventor: Samuel Slaboden, Culver City, CA (US)

(21) Appl. No.: 19/247,778

(22) Filed: Jun. 24, 2025

Related U.S. Application Data
(60) Provisional application No. 63/786,182, filed on Apr. 9, 2025.

(51) Int. Cl. E05B 47/00; E05F 15/624

(52) U.S. Cl. CPC E05B 47/0012; E05F 15/624; E05B 2047/0017; E05B 2047/002; E05B 2047/0069; E05Y 2400/32; E05Y 2900/132

(57) ABSTRACT

A smart automated door movement system includes a first assembly configured to unlatch a door and a second assembly configured to cause the unlatched door to move (e.g., to open). The first and second assemblies may be configured with a door and may be controlled via a mobile application running on a mobile device and/or may be voice activated. The first assembly may include a motorized mechanism that causes the door to unlatch, and the second assembly may include a motorized wheel that engages the ground to cause movement of the door. The system may be integrated into an Internet of Things (IoT) network as part of smart home technology.

### CROSS-REFERENCE TO RELATED APPLICATIONS

This application claims the benefit of U.S. Provisional patent application No. 63/786,182, filed Apr. 9, 2025, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

The present invention relates to doors, including an automated door opening and closing system and method.

### BACKGROUND

As is known, traditional doors are typically opened and closed manually using a doorknob assembly. Such doorknob assemblies typically include one or more handles that when rotated may unlatch the door so that the door may be manually opened.

However, oftentimes, a person's hands may be otherwise occupied (e.g., the person may be carrying a large item) such that it may be difficult to grasp the doorknob to open the door. In such an instance, the person may be forced to put the large item down, to open the door and to secure it open, to pick the large item back up, to pass through the doorway, to put the large item back down, and to close the door.

Accordingly, there is a need for an automated door movement system.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a general diagram of an automated door movement system according to exemplary embodiments hereof;

FIG. 2 shows a perspective view of a latching assembly according to exemplary embodiments hereof;

FIGS. 3, 4 and 4A show side views of portions of latching assemblies according to exemplary embodiments hereof;

FIG. 5 shows a perspective view of a movement assembly according to exemplary embodiments hereof; and

FIG. 6 shows a front view of a movement assembly according to exemplary embodiments hereof.

### DETAILED DESCRIPTION OF THE INVENTION

In general, an automated door movement system is provided. The automated door movement system may be configured with a door and may, on command, be caused to open and/or close the door. The door movement system may generally comprise a first assembly that unlatches and/or latches the door, and a second assembly that upon the unlatching of the door, may cause movement of the door, e.g., the opening and/or closing of the door. The system also may include sensors that sense activity in the physical areas surrounding the door, e.g., video cameras, microphones, motion detectors, etc., that may be configured to sense emergencies (e.g., a fire, a medical emergency, an attempted burglary, etc.) and/or other events or circumstances.

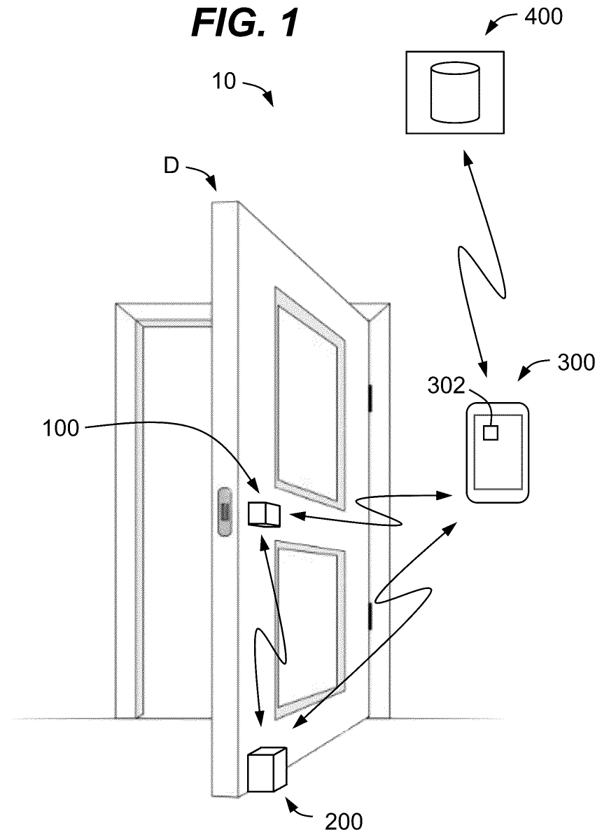

FIG. 1 shows a general non-limiting layout of an automated door movement system 10 configured with a door D within a door frame.

In some embodiments, as shown in FIG. 1, the automated door movement system 10 (also referred to herein as simply the system 10) includes a latching assembly 100, a movement assembly 200, a system controller 300, and a backend system 400 (e.g., a server or cloud platform). In general, the latching assembly 100 is configured with a door D to latch and/or unlatch the door D within the door frame, the movement assembly 200 is configured with the door D to move the door D when it is unlatched (e.g., to open and/or close the door D), the system controller 300 is designed to control the various aspects and functionalities of the automated door movement system 10, and the backend system 400 is configured to communicate with the latching assembly 100, the movement assembly 200, and/or with the controller 300, as well as with other external systems. The system 10 also may include an external sensor system 500 (e.g., integrated into the latching assembly 100, to sense activities, events, and/or circumstances in the physical areas surrounding the system 10. The system 10 also may include other elements as required to fulfill its functionalities.

For the purposes of this specification, the automated door movement system 10 will be described primarily in regard to its use in opening and/or closing a door. However, it is understood that this is for demonstration and that the automated door movement system 10 may be used to move other structures, e.g., partitions, panels, windows, gates, other types of structures that may benefit from the system 10, and/or any combinations thereof. It also is understood that the scope of the system 10 is not limited in any way by the types of structures that it may be configured to move.

In some embodiments, the system controller 300 may include a user device such as, but not limited to, a smartphone, a tablet computer, a laptop computer, a desktop computer, a mobile device, a personal electronics device, a robot (e.g., a home robot), any other suitable controller (e.g., any Internet of Things (IoT) controller), and/or any combinations thereof. In some embodiments, the system controller 300 may run one or more applications 302 (e.g., mobile applications, browser websites, etc.) that may be used to manage and/or otherwise control the system 10. The applications 302 may preferably include one or more graphical user interfaces (GUIs) that may be presented on the device's display and that include controls (e.g., touchscreen and/or mechanical buttons, etc.) that a user may activate to interact with the system 10. For example, the GUI may include controls and/or other mechanisms that enable the user to interface with the system 10 to log into the system 10, receive information from the system 10 (e.g., information regarding the status of the system 10 and/or the doors that it may be configured with), control the system 10, activate the system 10 (e.g., open or close a door), and to perform other functionalities. In some embodiments, the applications 302 may present instructions, wizards, and/or other types of guidance to the users via the GUI. In addition, the application 302 may accommodate any language and may be voice activated.

### Latching Assembly 100

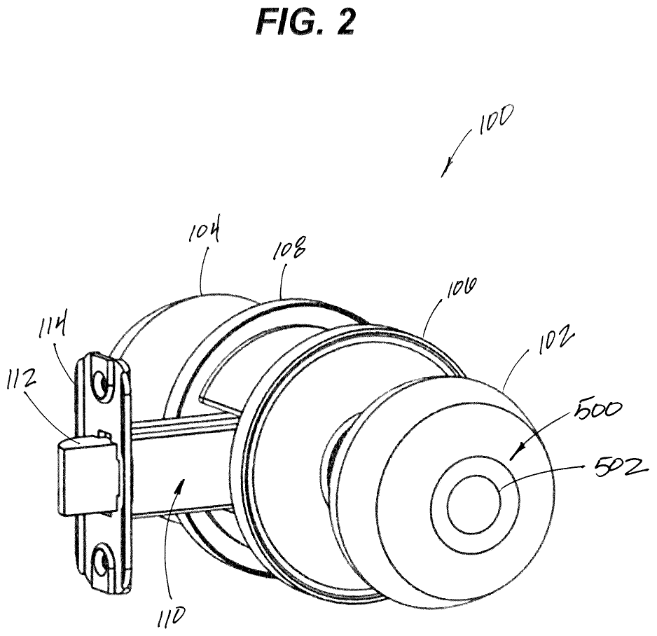

In some embodiments, the latching assembly 100 may generally resemble a traditional doorknob or handle assembly such that it may be implemented (e.g., installed and used) in a similar manner. This may minimize any additional modifications that may be made to the door. For example, as shown in FIG. 2, the latching assembly 100 may include inside handle 102 or knob, an outside handle 104 or knob, an inside rosette 106, an outside rosette 108, a latch assembly 110, a latch 112 or bolt, and a faceplate 114. In this way, the latching assembly 100 may be implemented into a door with a traditional doorknob assembly by simply removing the traditional doorknob assembly and replacing it with the latching assembly 100. It also is contemplated that the latching assembly 100 may not necessarily resemble a traditional doorknob assembly and may instead include one or more modifications to the door as necessary.

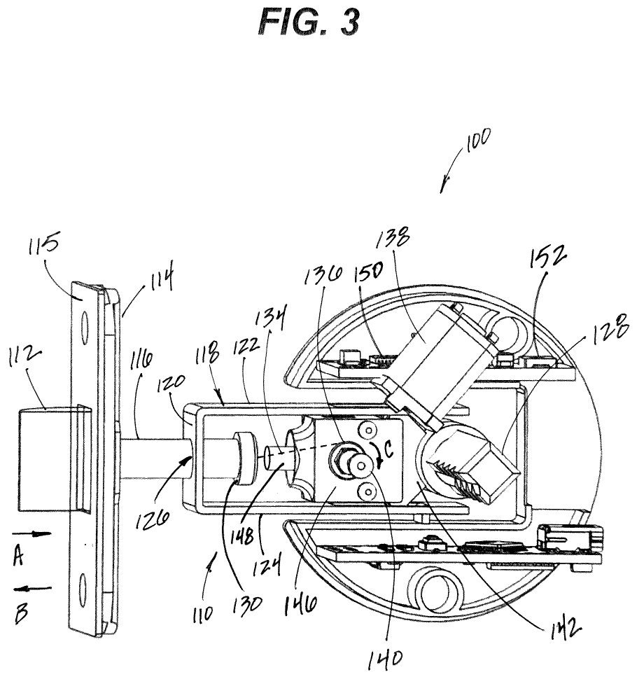

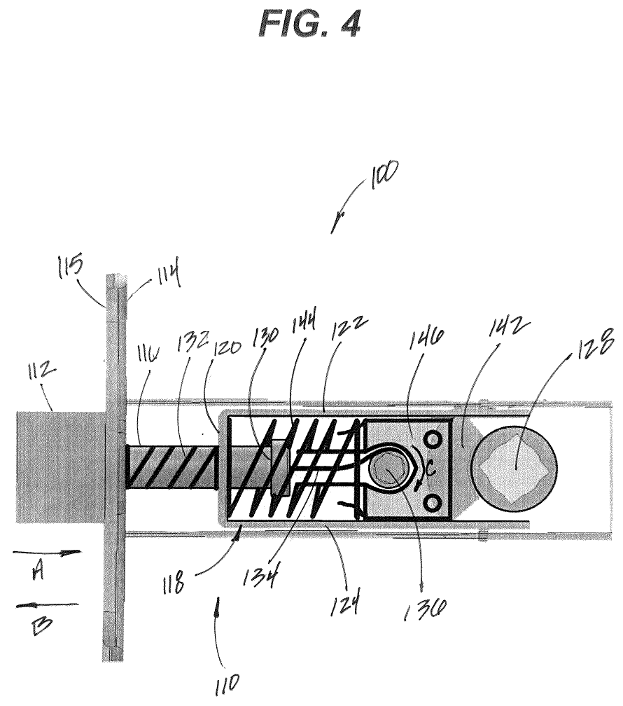

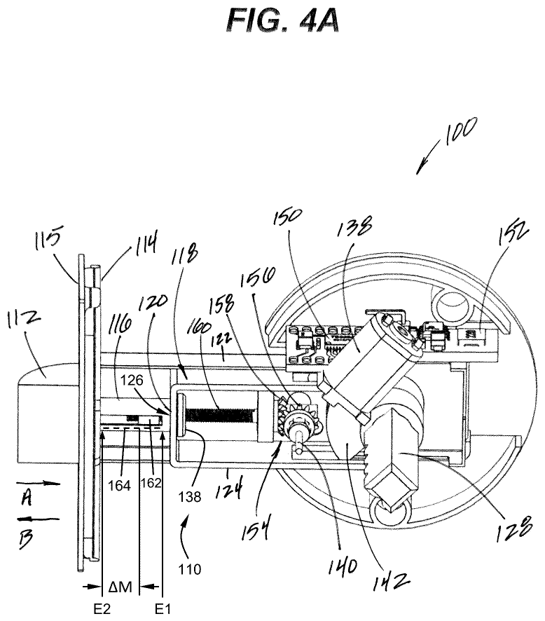

FIG. 3 shows the latching assembly 100 of FIG. 2 with the inside handle 102 the outside handle 104, the inside rosette 106, and the outside rosette 108 made transparent for clarity. The handle spindle 128 to which the inside handle 102 may be attached is still shown for reference. FIGS. 4 and 4A each show a side view of the latching assembly 100 with the forward elements made transparent for clarity.

In some embodiments, as shown in FIG. 3, the latching assembly's latch 112 may be caused to move in and/or out of the strike plate 115 (within the door jamb of the door frame) in the direction of the arrow A and/or in the direction of the arrow B to unlatch and latch the door, respectively. This movement of the latch 112 may be facilitated by movement of the latch rod 116 (also in the directions of the arrows A, B) to which the latch 112 may be connected. The latch rod 116 may include a distal end coupled to the latch 112 and a proximal end terminating within the latch assembly 110 (e.g., within the latch assembly bracket 118 as described below).

In some embodiments, the latch assembly 110 may include a latch assembly bracket 118 including a front plate 120, an upper arm 122 extending from an upper portion of the front plate 120, and a lower arm 124 extending from a lower portion of the front plate 120. The front plate 120, upper arm 122, and lower arm 124 may generally define an inner volume within the latch assembly bracket 118 within which the latch rod 116 may move. In some embodiments, the latch rod 116 may enter into the latch assembly bracket 118 through a hole 126 or opening in the bracket's front plate 120 such that the proximal end of the latch rod 116 resides within the latch assembly bracket 118.

In some embodiments, the latch rod 116, and therefore the latch 112, may be caused to move in the directions of the arrows A or B to latch and unlatch the latching assembly 100, respectively, by manual actuation (e.g., by grasping and rotating the inside and/or outside handle 102, 104), or by automatic control via the automated door movement system 10. This will be described in detail below.

In some embodiments, as shown in FIG. 3, the proximal end of the latch rod 116 positioned within the inner volume of the latch bracket 118 may include a circumferential notch 130 or stop (e.g., in the form of a circumferential ring) that may be dimensioned to be obstructed by (e.g., to not fit through) the assembly's opening 126 in its front plate 120. As such, movement of the proximal end of the latch rod 116 may be restricted to within the latch bracket's inner volume. In addition, as shown in FIG. 4, the latch assembly 110 may include a first spring 132 (e.g., a coil spring) configured with the latch rod 116 (e.g., encircling the rod 116) generally bookended in the area between the outer surface of the front plate 120 of the latch bracket 118 and the faceplate 114. As such, as the latch rod 116 (and the latch 112) is caused to move in the direction of the arrow A (e.g., to unlatch the door), the first spring 132 may compress and apply an outward bias to the latch 112 in the direction of the arrow B. As such, the latch rod 116 and the latch 112 may be spring-loaded by the first spring 132.

In some embodiments, as shown in FIGS. 3 and 4, to automate the unlatching of the latch 112, a latch line 134 may be configured within the latch assembly 110 including a first end coupled to the proximal end of the latch rod 116 and a second end coupled to and wrapped around a latch spindle 136. The latch line 134 may comprise plastic (e.g., nylon), metal, any other suitable materials, and/or any combinations thereof and may be in the form of a rope (e.g., braided nylon), a string, a chain, a solid line, a wire, a cable, a thread, any other suitable type of line, and/or any combinations thereof. The latch spindle 136 may be configured within a latch spindle housing 146 that may support the latch spindle 136 in an orientation generally perpendicular to the latch line 134 as it may rotate.

In some embodiments, as shown in FIGS. 3 and 4, as the latch spindle 136 is caused to rotate (e.g., in the direction of the arrow C), the latch line 134 may wind about the latch spindle 136 thereby pulling the latch rod 116 (and the latch 112) in the direction of the arrow A. As such, as the latch spindle 136 is rotated and the latch line 134 is spooled, the latch 112 may be moved to cause the unlatching of the latch assembly 100.

In some embodiments, as shown in FIG. 3, this process may be automated by including a latch motor 138 configured to rotate a rotary drive shaft 140 configured to rotate the latch spindle 136. The motor 138 may be controlled using an internal latching assembly controller 150 (or by another controller such as the system controller 300) as described in other sections. For example, the latch motor 138 may be controlled to rotate the latch spindle 136 for a predetermined amount of time known to cause sufficient spooling of the latch line 134 to cause sufficient longitudinal translation of the latch rod 116 to unlatch the latch 112. In other embodiments, sensors 152 may be used to determine the longitudinal position of the latch rod 116 and/or the latch 112, and/or the rotational position of the latch spindle 136 to determine sufficient translation of the latch 112 to unlatch the door. The sensors 152 will be described in further detail in other sections.

In some embodiments, to latch the latching assembly 100, the latch rod 116 and the latch 112 may be caused to move in the direction of the arrow B. To facilitate this, in some embodiments, with the latch rod 116 spring-loaded by the first spring 132, the latch spindle 136 may be released (e.g., enabled to rotate freely). The compressed first spring 132 may then be free to expand thereby exerting a force to the latch rod 116 and the latch 112 in the direction of the arrow B. This may cause the latch rod 116 to move and to unwind the latch line 134 from the latch spindle 136 (as the latch spindle 136 rotates in the direction generally opposite the direction of the arrow C). In other embodiments, the latch spindle 136 may be caused to move in the direction opposite the direction of the arrow C by the motor 138, and/or by other means.

In some embodiments, as shown in FIG. 3, the latch spindle housing 146 may include a hollow generally tubular line guard 148 extending outward from the front surface of the spindle housing 146 that may generally guide and protect the latch line 134 as it may be spooled and unspooled.

In some embodiments, the latch rod 116 (and the latch 112) may be caused to automatically move in the direction of the arrow A using other suitable types of rotational-to-linear movement actuators implemented into the latch assembly 100, e.g., a rack and pinion assembly. These may be implemented in addition to and/or instead of the latch spindle 136 and latch line 134 arrangement described above.

For example, in some embodiments, as shown in FIG. 4A, the latching assembly 100 may include a rotational-to-linear movement actuator including a gear assembly 154 comprising a first gear 156 (e.g., a first bevel gear) configured with the drive shaft 140 and arranged to drive a second gear 158 (e.g., a second bevel gear) configured with a threaded latch shaft 160. The drive shaft 140 may be configured with the latch motor 138 such that the latch motor 138 rotates the drive shaft 140 which in turn rotates the first gear 156 which in turn drives the second gear 158 which in turn rotates the threaded latch shaft 160. The threaded latch shaft 160 may extend through the latch assembly's opening 126 in its front plate 120 and into a longitudinal hollow portion of the latch rod 116. In addition, a threaded insert 162 (e.g., a nut) may be positioned within the hollow portion of the latch rod 116 and may be aligned to receive the threaded latch shaft 160 within its threaded central hole. In some embodiments, the inner circumferential surface of the latch rod's hollow portion includes a longitudinal slot 164 extending from a first slot end E1 within the hollow portion to a second slot end E2 within the hollow portion, and the threaded insert 162 includes an outer protrusion that rides longitudinally within the longitudinal slot 164. This embodiment also may include the first compressed spring 132 configured with the latch rod 116 as shown in FIG. 4.

When the threaded latch shaft 160 is rotated in a first direction to unlatch the latch 112, the threaded insert 162—which is constrained from rotating by its outer protrusion that rides within the longitudinal slot 164 within the interior of the hollow latch rod 116—translates linearly along the shaft in the direction of arrow A. As the threaded insert 162 moves in this direction, it reaches the first end E1 of the longitudinal slot 164 and engages the latch rod 116, exerting a force that drives both the latch rod 116 and the latch 112 in the direction of arrow A. This motion compresses the first spring 132 and causes the latch 112 to unlatch.

Conversely, when the threaded latch shaft 160 is rotated in a second direction opposite the first, the threaded insert 162 is caused to move in the direction of the arrow B. During this translation, the first end E1 of the longitudinal slot 164 remains in contact with the threaded insert 162 due to the restoring force applied by the compressed spring 132 on the latch rod 116. As rotation of the threaded latch shaft 160 in the second direction continues to move the threaded insert 162 in the direction of the arrow B, the latch rod 116 and the latch 112 also are caused to move in the same direction until the threaded insert 162 reaches the end of its travel at which time the latch 112 may be in its fully latched position.

In some embodiments, a default setting of the latch rod 116 and its threaded insert 162 places the threaded insert 162 at or near the first end E1 of the latch rod's inner longitudinal slot 164. This ensures that, upon automatic activation, the threaded insert 162 may immediately engage the first end E1 of the longitudinal slot 164 (the slot's end wall) to drive the latch rod 116 in the direction of arrow B. Because of this configuration, a sufficient portion ΔM of the longitudinal slot 164 between the slot's second end E2 and the threaded insert 162 remains unoccupied. This empty segment ΔM allows the latch rod 116 to move freely in the direction of arrow B, and to freely return in the direction of arrow A when manually operated. It is preferable that the segment ΔM include a sufficient length to enable sufficient movement of the latch 112 to latch and/or unlatch the latch 112 during manual operation.

In some embodiments, the latching assembly 100 may include a power source, e.g., a rechargeable battery, to power the latch motor 138 and other components within the assembly 100 that may require power. The latching assembly 100 also may include one or more physical ports for communications and/or power.

To manually unlatch the latching assembly 100, a user may grasp and rotate the inside and/or outside handle 102, 104. With the indoor and/or outdoor handles 102, 104 coupled to the handle spindle 128 (see FIG. 3), rotation of the handles 102, 104 may cause a corresponding rotation of the handle spindle 128. Rotation of the handle spindle 128 may cause upward and/or downward rotational movement of the handle cam 142 coupled thereto. The handle cam 142 may include an upper wing positioned within an upper slot within the assembly bracket's upper arm 122 and a lower wing positioned within a lower slot within the assembly bracket's lower arm 124. As such, as the handle spindle 128 is caused to rotate, the handle cam 142 may exert forces within the arm slots that cause the bracket assembly 118 to move in the direction of the arrow A. As the bracket assembly 118 moves in the direction of the arrow A, the bracket's front plate 120 may engage with the latch rod's circumferential notch 130 thereby causing the latch rod 116 (and the latch 112) to also move in the direction of the arrow A, thereby unlatching the latching assembly 100. As described above, manual unlatching of the assembly 100 may be performed independent of the automated latching system such that the door may be opened and/or closed regardless of whether the automated latching system is functional or not (e.g., during a power outage).

In some embodiments, as shown in FIG. 4, the latch assembly 110 may include a second spring 144 (e.g., a coil spring) configured with the latch rod 116 and/or with the threaded latch shaft 160 depending on the embodiment (e.g., encircling the rod 116 and/or threaded latch shaft 160) generally bookended in the area within the latch assembly's inner volume between the inner surface of the front plate 120 of the latch bracket 118 and the front surface of the latch spindle housing 146 and/or of the gear assembly 154. As such, as the latch rod 116 (and the latch 112) is manually caused to move in the direction of the arrow A (e.g., to unlatch the door), the second spring 144 may compress and apply an outward bias to the latch bracket 118 in the direction of the arrow B. As such, the latch bracket 118 may be spring-loaded by the second spring 144. Given this, when the inside and/or outside handle 102, 104 may be released, the second spring 144 may cause the latch bracket 118 to move in the direction of the arrow B. In addition, and preferably simultaneously, the first spring 132 may cause the latch rod 116 and the latch 112 to also move in the direction of the arrow B thereby latching the latching assembly 100.

In some embodiments, the latching assembly 100 may include a latching assembly controller 150 (e.g., a microcontroller, a microprocessor, etc.) and one or more sensors 152. The latching assembly controller 150 may be configured to control the components and functionalities of the latching assembly 100 (e.g., the latch motor 138 to spool the latch line 134, the rotary drive shaft 140 to drive the gears 156, 158, etc.). The latching assembly controller 150 also may interface with other elements of the system 10 such as the movement system's controller 238 (described in other sections), the system controller 300, and/or the backend system 400. This may include receiving information (e.g., commands, sensor readings, feedback, etc.) from the controllers 238, 300, 400 and outputting information (e.g., commands, sensor readings, feedback, etc.) to the controllers 238, 300, 400. The controllers 150, 238, 300, 400 may communicate with one another using wireless communications protocols such as Bluetooth, Wi-Fi, WAN, cellular, satellite, and/or other suitable communications techniques (including wired techniques). In some embodiments, the latching assembly controller 150 may be voice activated so that it may respond to voice commands from a user.

In one example, the latching assembly controller 150 may receive commands from the movement assembly controller 238 (and/or the other controllers 300, 400) to unlatch the door. Upon receiving this command, the controller 150 may perform the operations described herein (e.g., control the latch motor 138 to drive the drive shaft 140), and upon successfully performing the operations, may send confirmation to the movement assembly controller 238 (and/or the other controllers 300, 400) that the actions have successfully been taken. In this way, the movement assembly 200 may initiate movement of the door as described in other sections.

In another example, if the operations were not successful, the latching assembly controller 150 may send error notifications to the other controllers 238, 300, 400. In a further example, the latching assembly controller 150 may provide updates and/or feedback to the other controllers 238, 300, 400 regarding its status. It is understood that the controllers 150, 238, 300, 400 may interface and communicate with one another in any way as necessary for the system 10 to fulfill its functionalities.

In some embodiments, the movement assembly's one or more sensors 152 may sense the status, position, and/or other attributes of its components, such as the rotational position of the latch spindle 136, the longitudinal position of the latch rod 116 or latch 112, as well as other functional and/or operational attributes. The sensors 152 may then relay this information to the controller 150 as necessary. It is understood that the latching assembly 100 may include any type(s) of sensors 152 to sense any type of readings as required by the latching assembly 100.

### Movement Assembly 200

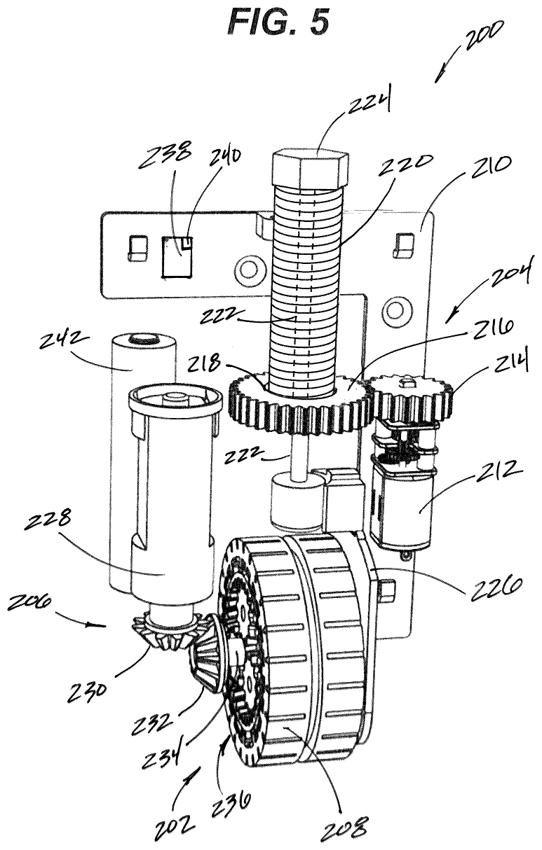

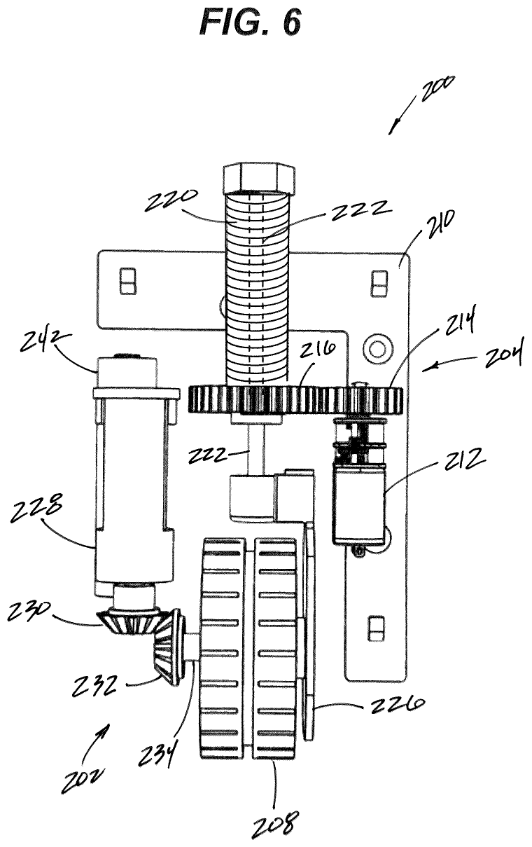

FIG. 5 shows a perspective view of the movement assembly 200 with the housing made transparent for clarity.

In some embodiments, as shown in FIG. 5, the movement assembly 200 includes a movement mechanism such as a wheel assembly 202, a wheel engagement assembly 204, and a wheel movement assembly 206. In general, the wheel assembly 202 includes a wheel 208 (or a continuous track, etc.) and its operational components, the wheel engagement assembly 204 includes mechanisms to lower and raise the wheel assembly 202 for engagement with the ground, and the wheel movement assembly 206 includes mechanisms to cause rotation of the wheel 208 thereby causing the door to move (e.g., to open or close). The various assemblies 202, 204, 206 and supporting components may be attached to a mounting bracket 210 that may be coupled to the door (preferably releasable). The mounting bracket 210 may preferably be configured to attach the movement assembly 200 a lower portion of the door generally opposite the hinged portion of the door as shown in FIG. 1. However, it is understood that the movement assembly 200 may be attached to the door at any suitable location.

In some embodiments, the wheel engagement assembly 204 may include a rotational movement to linear movement translation system such as a screw and nut system or other suitable actuation system. In some embodiments, the assembly 204 may include an engagement motor 212 configured to rotate a first engagement gear 214 (e.g., a 20-tooth spur gear or similar) that may be configured to engage and rotate a second engagement gear 216 (e.g., a 40-tooth spur gear or similar). The second engagement gear 216 may include a central inner circumferentially threaded nut 218 with inner threads that may engage the outer threads of a tubular (and generally vertical) movement member 220. In this way, rotational movement of the first engagement gear 214 by the engagement motor 212 may cause a corresponding rotation of the second engagement gear 216 and its inner threaded nut 218 thereby causing the linear up and/or down movement (depending on the direction of the rotation) of the tubular movement member 220.

In some embodiments, an engagement rod 222 may be configured longitudinally within the movement member 220 such that upward and/or downward movement of the movement member 220 causes a corresponding upward and/or downward movement of the engagement rod 222. The engagement rod 222 may be spring-loaded within the member 220 using a third spring (e.g., a coil spring) configured with the rod 222 (e.g., encircling the rod 222) and generally bookended between the upper and lower portions of the engagement member 220 within its inner volume.

In some embodiments, a cap 224 (e.g., a threaded hex cap) may be configured with the engagement rod 222 and the engagement member 220 (e.g., at the top of the member 220) to prevent free spinning of the member 220 and rod 222.

In some embodiments, the distal end of the engagement rod 222 may extend out the bottom of the engagement member 220 and be coupled to a wheel hub 226. The wheel hub 226 may be coupled to the wheel 208 via bearings or similar. In this way, as the engagement rod 222 is caused to move downward and/or upward, the wheel 208 also is caused to similarly move to engage and/or disengage with the floor. Furthermore, because the engagement rod 222 may be spring-loaded, as the engagement assembly 204 presses the wheel 208 to the ground, the rod 222 and the wheel 208 also may be enabled to move upward (against the bias of the third spring) to allow the wheel 208 to roll over small obstacles that may be on the ground, all while being pressed downward by the assembly 204 to maintain adequate traction with the ground.

In other embodiments, the engagement assembly 200 may include a rack and pinion assembly and/or any other suitable rotational-to-linear movement system to cause and control the up and down movement of the wheel 208. Other suitable movement systems also may be used.

In some embodiments, the wheel movement assembly 206 may include a wheel movement motor 228 configured to rotate a first gear 230 (e.g., a first bevel gear) which may in turn cause a corresponding rotation of a second gear 232 (e.g., a second bevel gear configured with the first bevel gear) that may be coupled to and cause the rotation of the wheel's axle 234 and the wheel 208 configured therewith. In some embodiments, as shown in FIG. 5, the wheel 208 may include a planetary drive gear system 236 including a ring gear, a center gear (a sun gear), and one or more driven gears (planet gears). The wheel 208 may include an outer tread comprising rubber, plastic, or other suitable material(s).

While the wheel movement system 206 has been described as using two (bevel) gears 230, 232 and a planetary gear system 236, it is understood that this is for demonstration and that the wheel movement assembly 206 may implement other types of gears and/or arrangement of gears to provide the controlled rotational movement of the wheel 208.

In some embodiments, the movement assembly 200 may include a movement assembly controller 238 (e.g., a microcontroller, a microprocessor, etc.) and one or more sensors 240. The movement assembly controller 238 may interface with the latching assembly controller 150, the system controller 300, and/or the backend system 400. In some embodiments, the movement assembly controller 238 may be voice activated so that it may respond to voice commands from a user.

For example, the movement assembly controller 238 may receive information (e.g., commands) from the system controller 300, the latching assembly controller 150, or a voice command from a user, and may output information (e.g., sensor readings and feedback) to the other controllers 150, 300, 400. The controllers 238, 150, 300, 400 may communicate with one another using wireless communications protocols such as Bluetooth, Wi-Fi, WAN, cellular, satellite, and/or other suitable communications techniques. The movement assembly controller 238 also may receive information from the one or more sensors 240 and control the engagement motor 212, the wheel movement motor 228, and/or other components within the movement assembly 200 accordingly.

In some embodiments, the one or more sensors 240 may include a first sensor configured to employ auto leveling of the wheel 208 for adjusting wheel traction during normal operating conditions and for when encountering uneven or obstructed terrain. For example, the wheel movement motor 228 may cause the wheel 208 to spin and the wheel engagement assembly 204 may lower the wheel 208 to detect ground contact. A current sensor may then be used to sense the current level of the wheel movement motor 228 during operation to determine different operating conditions. In one example, if a high current is sensed, the downward wheel bias may be considered high and the wheel engagement assembly 204 may be instructed to slightly raise the wheel 208. Conversely, if a low current is sensed, the downward wheel bias may be considered low and the wheel engagement assembly 204 may be instructed to slightly lower the wheel 208. In another example, if the sensed current remains high even after the wheel 208 is slightly raised, this may indicate an obstruction to the wheel 208 and the wheel movement assembly 206 may be instructed to reverse direction of the wheel 208 so that the obstruction may be removed. In this case, the movement assembly controller 238 may send the system controller 300 a message to alert the user of the potential obstruction so the issue may be resolved.

In another example, the sensors 240 may include door position and motion control sensors such as, but not limited to, magnetometers, accelerometers, gyroscopes, infrared (IR) sensors, etc. These sensors may include MEMS sensors or similar. For instance, a gyroscope and/or an accelerometer may be configured to detect changes in the angular position of the door and its motion, enabling the system 10 to track the door's movement and position in real time. In addition, a magnetometer may be used to calibrate the movement assembly 200 by determining and logging an absolute reference position of the door (e.g., when the door is in its fully closed position). This may enable the system 10 to know the door's exact position relative to the reference position at any time, even after power interruptions. In another example, an IR sensor may be configured with the movement assembly 200 (or the latching assembly 100) to sense the location of the door frame or adjacent wall with respect to the door in order to determine the door's location in real time. Additionally, the IR sensor may be configured to sense obstacles (e.g., on the ground) that may obstruct the door or the system 10, and to alert the system 10 and/or the user of the obstacles for removal.

In any of these examples, the sensed information provided by the sensors 240 may be processed by the assembly's controller 238 and/or may be communicated to the system controller 300 for processing. In addition, any commands to the functional elements of the movement assembly 200 may be provided by the assembly's controller 238, by the system controller 300, and/or by any combinations thereof.

As shown in FIG. 5, the movement assembly 200 may include an internal power source 242 (e.g., a rechargeable battery) that may provide power to the various electronic components of the assembly 200. The movement assembly 200 also may include one or more physical ports for communications and/or power.

### Exterior Sensor System 500

In some embodiments, as shown in FIG. 2, the system 10 may include an exterior sensor system 500 including one or more sensors 502 configured with the system 10 (e.g., with the handles 102, 104 of the latching system 100) designed and implemented to sense activities, events, and/or circumstances in the physical environments surrounding the system 10.

In some embodiments, the sensors 502 may include one or more video cameras, motion detectors, microphones, and/or temperature sensors.

In some embodiments, the sensors 502 may capture data from the physical areas on either side of the door, e.g., sensors 502 implemented in the inner door handle 102 may capture data from areas adjacent a first side of the door (e.g., inside areas), and sensors 502 implemented in the outer door handle 104 may capture data from areas adjacent a second side of the door (e.g., outside areas).

In some embodiments, the motion sensors may sense motion and may trigger the video cameras to record video data. In other embodiments, the video camera and/or the microphones may be used to continually monitor a particular area (e.g., a baby nursery) and provide the video and audio data to the user in real time via the mobile application 302.

In other embodiments, the microphone may sense an alarm (e.g., a fire alarm within the home) and may trigger the mobile application 302 to send a message to the user accordingly. In this scenario, the system 10 also may close the door adjacent the sensed fire alarm (if programmed to do so) to contain any potential fire.

In other embodiments, the sensors 502 may sense a medical emergency (e.g., the microphone may sense a sudden crash and/or an audible call for help), and the system 10 may send a message to the user and/or contact emergency services (e.g., 9-1-1) to report the incident and provide the address, etc. for first responders. The system 10 also may be enabled by the user to identify the first responders as they approach the house and automatically open the door for them as described herein.

In other embodiments, the sensors 502 may sense a security event (e.g., an attempted burglary) and may take video data, audio data, and proximity data, and may notify the user and/or a security entity or police department via the mobile application 302 accordingly.

In some embodiments, the temperature sensor(s) may work in conjunction with the motion detectors such that as the motion detectors sense that a room is occupied, the temperature sensors may trigger a thermostat to adjust the temperature of the room accordingly (e.g., increase the temperature to a comfortable setting). If the temperature sensor detects that a room is unoccupied, it may notify the system controller 300 of this, and the room may then be heated or cooled using traditional baseline settings. In addition, when no one is home, the system 10 may operate using traditional baseline settings. This occupancy detection functionality may account for the fact that some rooms may cool or heat more quickly than others (e.g., a smaller bedroom vs. a larger living room). For example, by recognizing that someone is in the bedroom, the system can deprioritize the living room's temperature, allowing the HVAC system to run for a shorter duration, ultimately reducing utility costs. At any time, the user may override any of these automated settings and the system 10 may be set to manage the heating and/or cooling of any specific room(s) as if they were occupied.

In another example, in homes with multiple sensor systems 500 installed (e.g., in multiple latching assemblies 100 installed on multiple doors), the system 10 and sensors 502 may work collaboratively to optimize airflow by intelligently opening and closing doors to create subtle pressure changes within the corresponding rooms. These changes may help direct air more precisely throughout the home. Each respective temperature sensor may monitor how quickly different areas respond to heating or cooling, thereby enabling the system to build a baseline understanding of the home's thermal behavior. Combined with data from the Home Mapping feature of the mobile application 302, the system 10 may continuously refine its strategy—adjusting door positions dynamically to enhance airflow and improve overall energy efficiency.

It is understood that the system 10 may utilize its sensors 502 in any way and under any circumstances that may benefit from such use.

### In Use

In some embodiments, the system 10 may receive a command from a user to open a door that may be configured with the system 10. The command may be a voice command, a command initiated via a mobile application 302 running on an electronic device 300, and/or other type of command.

Upon receiving the command, the system 10 may initiate the latching assembly 100 to unlatch the door, and once it is confirmed that the door is unlatched, to open the door. As such, the latching assembly 100 may receive the command (from the movement assembly controller 238, the system controller 300, or from the backend system 400) and may cause the door to be unlatched as described herein. The latching assembly 100 may then inform the movement assembly 200 that the door is unlatched, and the movement assembly 200 may then implement the opening of the door as described herein.

In some embodiments, the default position of the movement assembly 200 is in its upper locked position such that the wheel 208 is not engaged with the ground. In this way, the movement assembly 200 is generally disengaged, and the door is thereby unobstructed by the movement assembly 200, until commanded to move the door. This provides that the door may be manually opened at any time (e.g., due to an emergency such as a fire or power outage) without having to interface with the system 10.

In some embodiments, if the door is already unlatched, the latching assembly 100 may inform the movement assembly 200 of this fact and the movement assembly 200 may proceed with opening the door.

In some embodiments, if the door is already open, the system 10 may determine to what extent the door is open and may cause the door to open further or may alert the user that the door already is open.

Similar steps may be taken to close the door, and to perform other door movement activities.

It is understood that any details and/or aspects of any embodiments of the automated door movement system 10 described herein may be combined with any details and/or aspects of any other embodiments of the automated door movement system 10 in any way to form additional embodiment(s) of the automated door movement system 10 all of which are within the scope of the automated door movement system 10.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs” and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values, and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A door movement system comprising:
a door latching assembly configured with a door and including a door latch and a motorized latch movement system adapted to move the door latch from a latched position to an unlatched position;
a door movement assembly configured with the door and including a motorized wheel adapted to releasably engage a ground surface to move the door;
wherein the door movement assembly is notified when the door latching assembly moves the door latch to the unlatched position, and is subsequently controlled to move the door.

2. The door movement system of claim 1 wherein the motorized latch movement system includes a rotational-to-linear movement system.

3. The door movement system of claim 2 wherein the rotational-to-linear movement system includes a gear assembly configured with a threaded shaft and/or a spindle configured to spool a line.

4. The door movement system of claim 1 wherein the door latching assembly includes a manual cam assembly adapted to move the door latch from the latched position to the unlatched position.

5. The door movement system of claim 4 wherein the manual cam assembly operates independently of the motorized latch movement system.

6. The door movement system of claim 4 wherein the motorized latch movement system includes a first compressed spring and the manual cam assembly includes a second compressed spring.

7. The door movement system of claim 6 wherein the first compressed spring causes the latch to move to the latched position if the latch was moved to the unlatched position by the motorized latch movement system, and the second compressed spring causes the latch to move to the latched position if the latch was moved to the unlatched position by the manual cam assembly.

8. The door movement system of claim 1 further comprising a latch position sensor adapted to determine a longitudinal position of the latch.

9. The door movement system of claim 1 wherein the door movement assembly includes a vertical movement member configured to lower and/or raise the motorized wheel.

10. The door movement assembly of claim 9 wherein the vertical movement member is controllably motorized.

11. The door movement system of claim 9 wherein the door movement assembly includes a wheel position sensor adapted to determine a vertical position of the wheel.

12. The door movement assembly of claim 9 wherein the door movement assembly includes a wheel traction sensor adapted to determine a traction level of the wheel to the ground surface.

13. The door movement assembly of claim 9 wherein the door movement assembly includes a door position sensor adapted to determine a position of the door.

14. The door movement system of claim 1 further comprising one or more sensors, including a video camera, a motion detector, a microphone, and a temperature sensor.

15. The door movement system of claim 14 wherein at least one sensor is configured with an inside handle and/or an outside handle configured with the door movement system.
